(19) United States
(12) Patent Application Publication
(10) Pub. No.: US 2004/0033304 A1
(43) Pub. Date: Feb. 19, 2004

(54) Beer-containing beverage

(76) Inventor: Gunther Scheler, Wien (AT)

Correspondence Address: HENRY M FEIEREISEN, LLC, 350 FIFTH AVENUE, SUITE 4714, NEW YORK, NY, 10118, US

(21) Appl. No.: 10/413,941

(22) Filed: Apr. 15, 2003

(30) Foreign Application Priority Data
Aug. 13, 2002 (AT) GM 542/02

(51) Int. Cl. C12G 1/00

(52) U.S. Cl. 426/592

(57) ABSTRACT

A beer beverage contains a physiologically suitable component, in particular pumpkinseed extract in the amount of 0.01 to 1% of a pumpkinseed extract relative to the total amount of beverage.

### CROSS-REFERENCES TO RELATED APPLICATIONS

This application claims the priority of Austrian Patent Application, Serial No. GM 542/02, filed Aug. 13, 2002, pursuant to 35 U.S.C. 119(a)-(d), the disclosure of which is incorporated herein by reference.

### BACKGROUND OF THE INVENTION

The present invention relates to a beverage and in particular to a beer-containing beverage.

Beer-containing beverages are known in the prior art already in connection with a number of mixed beverages, with one of the beverages known for example, in Europe, as a “Radler”, that is a mixture of conventional beer and a soft drink. Other already known beer beverages are for example, a spiced beer known as “chili beer” and similar beverages, where beer has been pre-mixed with a number of flavorings.

Also known in the prior art are a variety of beers that are brewed for special occasions such as, for example, where recipes for beer brewing are modified to provide a heavier beer with more alcohol or a lighter beer with less alcohol or where the beer has more hop flavor and other similar variations.

However such beers provide no special beneficial effect other than taste variations.

It would therefore be desirable and advantageous to provide a beer beverage which obviates prior art shortcomings and which has physiologically beneficial properties directed to a healthful purpose, and which has a pleasant taste.

### SUMMARY OF THE INVENTION

According to one aspect of the present invention, a beer-containing beverage is provided which has a physiological effect beyond that of the known beers and beer beverages, while at the same time preserving to a great degree the regular taste of beer.

The present invention resolves prior art problems by providing a beer-containing beverage that contains a defatted extract from pumpkinseeds. The beneficial properties of defatted extract from pumpkinseeds works can effect a beneficial quality in conjunction with the beer by supporting the diuretic property of the beer when it is part of the beer beverage. By incorporating the defatted extract of pumpkinseed into the beer beverage an agreeable taste is realized producing a slightly viscous feeling in the mouth, and has been deemed to have a more “haptic body”. In addition, it has a nut flavor.

With respect to the physiological effect of the pumpkinseed extract, the German federal health administration published a monograph in 1989, which recommends intake of a dose of 10 grams of pumpkinseeds per day for the condition of an enlarged prostate in men (up to stage II of the disease) and for women with weak bladder syndrome. Gynecologists and urologists likewise recommend this extract for the afore-stated conditions.

In order to realize a balance between beer taste and the taste of the pumpkinseed extract, the total amount of beverage contains between 0.01 and 1% of defatted pumpkinseed extract, preferably 0.05-0.5% and especially preferred 0.1 to 0.2%.

To realize a suitable solubility in the beer, the pumpkinseed extract can be an ethanol/water extract of pharmaceutical purity. For a particularly advantageous processing, the ratio of active ingredient to pumpkinseed extract formulation is approximately 1:5 to 1:25, and especially 1:15.

### DETAILED DESCRIPTION OF A PREFERRED EMBODIMENT

In a preferred embodiment of the present invention, after having undergone the process of brewing, storing and filtering, the beer is mixed with 0.16% of a pumpkinseed extract having a concentration ratio of 1:15, which corresponds to approximately 0.5 g/0.33 l bottle. The beer can be a beer of weakly hopped common light beer of low fermentation having an alcohol content of 4.7% by volume with an original ‘wort’ value of approximately 10.8° Balling, which corresponds to a draft beer. Alcohol-free beers can also be used.

Of course other, special beer mixtures can also be used, whereby it is pointed out that it is essential to keep the ratio of flavoring of the pumpkinseed extract relative to the bitter stuff of the hops in the beer at a balance so as to retain a well balanced taste.

If so desired, the beverage mixed according to the foregoing example, can also be pasteurized and then filled in bottles.

In accordance with a further preferred embodiment, 0.24% pumpkinseed extract can be added in the above example, whereby the beer beverage is provided with a more pronounced pumpkinseed extract flavor.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A beer-containing beverage comprising beer mixed with defatted pumpkinseed extract.

2. The beer-containing beverage of claim 1, wherein the beverage contains an amount of defatted extract of pumpkinseed in the range of 0.01-1%.

3. The beer containing beverage of claim 2, wherein the beverage contains an amount of defatted extract of pumpkinseed 0.05-0.5%.

4. The beer containing beverage of claim 2, wherein the beverage contains an amount of defatted extract of pumpkinseed 0.1-0.2%.

5. The beer containing beverage of claim 1, wherein the defatted extract of pumpkinseed is an ethanol/water extract of pharmaceutical purity.

6. The beer containing beverage of claim 1, wherein the defatted extract of pumpkinseed has a ratio from 1:5 to 1:25 of amount of prepared extract to pumpkinseed.

7. The beer containing beverage of claim 6, wherein the ratio is 1:25.

8. The beer containing beverage of claim 6, wherein the ratio is 1:15.

9. The beer containing beverage of claim 6, wherein the ratio is 1:5.

10. The beer-containing beverage of claim 1, wherein the beer is a weakly hopped draft beer.
